(19) United States
(12) Patent Application Publication
(10) Pub. No.: US 2019/0345070 A1
(43) Pub. Date: Nov. 14, 2019

(54) Pneumatic Cooling and Transport Apparatus for Extrusion Reaction Manufacturing of Polymer Derived Ceramics

(71) Applicant: Melior Innovations, Inc., Houston, TX (US)

(72) Inventor: Richard Landtiser, Naperville, IL (US)

(73) Assignee: Melior Innovations, Inc., Houston, TX (US)

(21) Appl. No.: 16/212,615

(22) Filed: Dec. 6, 2018

Related U.S. Application Data
(60) Provisional application No. 62/595,511, filed on Dec. 6, 2017.

(51) Int. Cl. C04B 35/571; B28B 13/02; B28B 17/00

(52) U.S. Cl. CPC C04B 35/571; B28B 13/02; C04B 2235/6021; C04B 2235/3895; B28B 17/00

(57) ABSTRACT

Methods for forming small volumetric shapes of polymer derived ceramic materials, including reaction extrusion systems and processes. Systems and apparatus for forming small volumetric shapes of polymer derived ceramic materials, cured materials and pyrolized materials, including extruders. Polysilocarb polymer derived ceramic precursor formulations. A pneumatic handling device in associated with the extruder. The pneumatic handling device can cool, mix, mill and transport the cured material.

This application claims under 35 U.S.C. § 119(e)(1) the benefit of U.S. provisional application Ser. No. 62/595,511, filed Dec. 6, 2017, the entire disclosure of which is incorporated herein by reference.

### BACKGROUND OF THE INVENTION

### Field of the Invention

The present inventions relate to methods and systems for manufacturing polymeric derived ceramic materials in small volumetric shapes.

Polymer derived ceramics (PDC) are ceramic materials that are derived from, e.g., obtained by, the pyrolysis of polymeric materials. These materials are typically in a solid or semi-solid state that is obtained by curing an initial liquid polymeric precursor, e.g., PDC precursor, PDC precursor formulation, precursor batch, and precursor. The cured, but unpyrolized, polymer derived material can be referred to as a preform, a PDC preform, the cured material, and similar such terms. Polymer derived ceramics may be derived from many different kinds of precursor formulations, e.g., starting materials, starting formulations. PDCs may be made of, or derived from, carbosilane or polycarbosilane (Si—C), silane or polysilane (Si—Si), silazane or polysilazane (Si—N—Si), silicon carbide (SiC), carbosilazane or polycarbosilazane (Si—N—Si—C—Si), siloxane or polysiloxanes (Si—O), to name a few.

A preferred PDC is “polysilocarb”, e.g., material containing silicon (Si), oxygen (O) and carbon (C). Polysilocarb materials may also contain other elements. Polysilocarb materials can be made from one or more polysilocarb precursor formulation or precursor formulation. The polysilocarb precursor formulations can contain, for example, one or more functionalized silicon polymers, other polymers, non-silicon based cross linking agents, monomers, as well as, potentially other ingredients, such as for example, inhibitors, catalysts, initiators, modifiers, dopants, fillers, reinforcers and combinations and variations of these and other materials and additives. Silicon oxycarbide materials, SiOC compositions, and similar such terms, unless specifically stated otherwise, refer to polysilocarb materials, and would include liquid materials, solid uncured materials, cured materials, and ceramic materials.

Examples of PDCs, PDC formulations and starting materials, are found in US Patent Publication Nos. 2014/0343220, 2014/0274658, 2014/0326453, 2015/0175750, 2015/0252166, 2008/0095942, 2008/0093185, 2006/0069176, 2006/0004169, and 2005/0276961, and U.S. Pat. Nos. 9,499,677, 8,742,008, 8,119,057, 7,714,092, 7,087,656, 5,153,295, and 4,657,991, the entire disclosures of each of which are incorporated herein by reference.

Generally, the term “about” and the symbol “˜” as used herein, unless specified otherwise, is meant to encompass a variance or range of ±10%, the experimental or instrument error associated with obtaining the stated value, and preferably the larger of these.

As used herein, unless specified otherwise the terms %, weight % and mass % are used interchangeably and refer to the weight of a first component as a percentage of the weight of the total, e.g., formulation, mixture, material or product. As used herein, unless specified otherwise “volume %” and “% volume” and similar such terms refer to the volume of a first component as a percentage of the volume of the total, e.g., formulation, material or product.

As used herein, unless specified otherwise, the recitation of ranges of values, a range, from about “x” to about “y”, and similar such terms and quantifications, includes each item, feature, value, amount or quantity falling within that range. As used herein, unless specified otherwise, each and all individual points within a range are incorporated into this specification, are a part of this specification, as if it were individually recited herein.

This Background of the Invention section is intended to introduce various aspects of the art, which may be associated with embodiments of the present inventions. Thus, the forgoing discussion in this section provides a framework for better understanding the present inventions, and is not to be viewed as an admission of prior art.

### SUMMARY

Accordingly, there has been a long-standing, unmeet and increasing need for small polymer derived ceramics and solids, methods of making these volumetric structures, and in particular methods of making predetermined shapes and volumes of these structures. The present inventions, among other things, solve these needs by providing the articles of manufacture, devices and processes taught, disclosed and claimed herein.

Thus, there is provided a system for making small volumetric structures from a polymer derived ceramic precursor, the system comprising: a polymer derived ceramic precursor delivery apparatus comprising: an injection port; and, an extruder barrel having a plurality of sections; wherein a section of the plurality of sections is a mixing section having a temperature from about 70 C to about 300 C; a pneumatic cooling and transport section; wherein, the system is capable of receiving a liquid polymer derived ceramic precursor; and whereby the system is capable of curing the liquid polymer derived ceramic precursor in the extruder barrel to form a cured polymer derived ceramic material.

Moreover, there is provided these systems and methods having one or more of the following features: wherein the injection port is filled with a liquid polymer derived ceramic precursor; wherein the pneumatic cooling and transport section comprises a gas inlet, a cured polymer derived ceramic material inlet, a venture chamber, and an outlet; wherein the extruder barrel is filled with the polymer derived ceramic precursor formulation; wherein the extruder barrel has a distal end and a proximal end, wherein the proximal end is adjacent the injunction port; and wherein the distal end of the barrel is filled with cured polymer derived ceramic material; wherein the extruder barrel has 8 zones, the zones comprising: an input zone having a temperature of 200-400 F; a first mix zone having a temperature of 200-400 F; a second mix zone having a temperature of 350-500 F; a third mix zone having a temperature of 350-500 F; a first mix/transfer zone having a temperature of 375-500 F; a second mix/transfer zone having a temperature of 375-550 F; a first transfer zone having a temperature of 375-425 F; and a die zone having a temperature of 50-80 F; wherein the liquid polymer derived ceramic precursor is selected from the group consisting of silanes, polysilanes, silazanes, polysilazanes, carbosilanes, polycarbosilanes, siloxanes, and polysiloxanes; wherein the liquid polymer derived ceramic precursor is a polysilocarb; wherein the cured polymer derived ceramic material is a neat material; wherein the cured polymer derived ceramic precursor is a reinforced polysilocarb; wherein the liquid polymer derived ceramic precursor comprises a polysilocarb and contains hydride groups; wherein the liquid polymer derived ceramic precursor comprises a polysilocarb, is solvent free, and contains hydride groups; wherein the liquid polymer derived ceramic precursor comprises a polysilocarb and contains vinyl groups; wherein the liquid polymer derived ceramic precursor comprises a polysilocarb having hydride and vinyl groups and wherein the molar ratio of hydride groups to vinyl groups is about 1.50 to 1; and wherein the liquid polymer derived ceramic precursor comprises a polysilocarb having hydride and vinyl groups and wherein the molar ratio of hydride groups to vinyl groups is about 3.93 to 1.

Furthermore, there is provided an extruder system for making cured polysiloxane polymer derived ceramic materials the extruder comprising: a drive section; the drive section mechanically engaging a gear box; and the gear box mechanically engaging a first and a second screw; whereby the drive section and gear box form an assembly capable of rotating the screws; the screws being located within an extruder barrel; the extruder barrel having a distal end and a proximal end; the extruder barrel and screws configured to form a plurality of sections; a first barrel section comprising an injection port having a liquid polymer derived ceramic precursor, the injunction port in fluid communication with a holding tank for the liquid polymer derived ceramic precursor; the first barrel section filled with the liquid polymer derived ceramic precursor; the first barrel section configured to cure the liquid polymer derived ceramic precursor; the screws in the first barrel section configured to advance the liquid precursor distally toward a second barrel section; the second barrel section configured to cure the liquid into a partially cured gelatinous polymer derived ceramic precursor; at least a portion of the second barrel section filled with the partially cured gelatinous polymer derived ceramic precursor; the screws in the second barrel section configured to advance the gelatinous polymer derived ceramic precursor distally toward a third barrel section configured to cure the gelatinous precursor into a cured solid polymer derived ceramic precursor; at least a portion of the third barrel section filled with the cured solid polymer derived ceramic precursor; the distal end of the barrel having an opening, the opening at least partially filled with the cured solid polymer derived ceramic precursor; the distal end in operational association with a pneumatic section, whereby the cured precursor is provided into an inlet of the pneumatic section and mixed with an in flowing gas stream, whereby the cured material is carried by the gas stream.

Moreover, there is provided these systems and methods having one or more of the following features: wherein the polymer derived ceramic precursor comprises methyl hydrogen fluid; and wherein the pneumatic section cools the cured material, transports the material to a predetermined destination, or both; wherein the polymer derived ceramic precursor comprises DCPD; wherein the polymer derived ceramic precursor comprises DCPD and methyl hydrogen fluid; wherein the first barrel section comprises a second injection port; wherein the second injection port contains a second material that is different from the liquid polymer derived ceramic precursor in the first injection port; wherein the second material is a liquid polymer derived ceramic precursor; wherein the second material is a catalysis; and wherein the second material is a silicon having a cyclic structure.

Additionally, there is provided a method for making volumetric structures in a reaction extruder, the method comprising: adding a liquid polymer derived ceramic into an extruder, the extruder comprising a barrel, mixing and curing the liquid polymer derived ceramic in the barrel, and delivering from the barrel into a pneumatic section a cured polymer derived ceramic material.

Moreover, there is provided these systems and methods having one or more of the following features: wherein the polymer derived ceramic precursor comprises methyl hydrogen fluid; and wherein the pneumatic section cools the cured material, transports the material to a predetermined destination, or both; wherein the polymer derived ceramic precursor comprises DCPD; and wherein the pneumatic section cools the cured material, transports the material to a predetermined destination, or both; wherein the polymer derived ceramic precursor comprises DCPD and methyl hydrogen fluid; and wherein the pneumatic section cools the cured material, transports the material to a predetermined destination, or both; and wherein the extruder barrel has 8 zones, the zones comprising: an input zone having a temperature of 200-400 F; a first mix zone having a temperature of 200-400 F; a second mix zone having a temperature of 350-500 F; a third mix zone having a temperature of 350-500 F; a first mix/transfer zone having a temperature of 375-500 F; a second mix/transfer zone having a temperature of 375-550 F; a first transfer zone having a temperature of 375-425 F; and a die zone having a temperature of 50-80 F and a pneumatic section having a gas temperature of 15-80 F; and wherein the liquid polymer derived ceramic precursor is selected from the group consisting of silanes, polysilanes, silazanes, polysilazanes, carbosilanes, polycarbosilanes, siloxanes, and polysiloxanes; wherein the gas temperature is 15-50 F.

Moreover there is provided a method for making volumetric structures in a reaction extruder, the method comprising: adding a liquid polymer derived ceramic precursor into an extruder, the extruder comprising a barrel, mixing and curing the liquid polymer derived ceramic in the barrel, and delivering at least about 95% of the liquid polymer derived ceramic precursor from the barrel as cured polymer derived ceramic material into a pneumatic device, wherein the material is cooled, mixed, transported or two or more of these.

Additionally, there is provided a method for making volumetric structures in a reaction extruder, the method comprising: adding a liquid polymer derived ceramic precursor into an extruder, the extruder comprising a barrel, mixing and curing the liquid polymer derived ceramic in the barrel, and delivering at least about 99% of the liquid polymer derived ceramic precursor from the barrel as cured polymer derived ceramic material into a pneumatic device, wherein the material is cooled, mixed, transported or two or more of these.

Further there is provided a method for making volumetric structures in a reaction extruder, the method comprising: adding a liquid polymer derived ceramic precursor into an extruder, the extruder comprising a barrel, mixing and curing the liquid polymer derived ceramic in the barrel, and delivering at least about 99.5% of the liquid polymer derived ceramic precursor from the barrel as cured polymer derived ceramic material into a pneumatic device, wherein the material is cooled, mixed, transported or two or more of these.

Yet moreover, there is provided a method for making volumetric structures in a reaction extruder, the method comprising: adding a liquid polymer derived ceramic precursor into an extruder, the extruder comprising a barrel, mixing and curing the liquid polymer derived ceramic in the barrel, and delivering at least about 99.9% of the liquid polymer derived ceramic precursor from the barrel as cured polymer derived ceramic material into a pneumatic device, wherein the material is cooled, mixed, transported or two or more of these.

Moreover, there is provided these systems and methods having one or more of the following features: wherein the volume is less than about 0.25 inch³ and wherein the gas temperature in the pneumatic device is a selected from the group costing of 10-100 F, 10-40 F, 20-50 F, 30-60 F, and 20-45 F; wherein the volume is less than about 500 mm³ and wherein the gas temperature in the pneumatic device is a selected from the group costing of 10-100 F, 10-40 F, 20-50 F, 30-60 F, and 20-45 F; wherein the volume is than about 50 microns³ and wherein the gas temperature in the pneumatic device is a selected from the group costing of 10-100 F, 10-40 F, 20-50 F, 30-60 F, and 20-45 F; wherein the preform is green cured and wherein the gas temperature in the pneumatic device is a selected from the group costing of 10-100 F, 10-40 F, 20-50 F, 30-60 F, and 20-45 F; wherein the cured material is hard cured; wherein the cured material is final cured; wherein the liquid polymer derived ceramic precursor is a polysilocarb.

Still additionally there is provided a method for making small volumetric structures from a polymer derived ceramic precursor, the method comprising: adding a liquid polymer derived ceramic precursor to an extruder apparatus, the extruder comprising: an injection port; and, an extruder barrel having a plurality of sections; wherein a section of the plurality of sections is a mixing section having a temperature from about 70 C to about 300 C; a pneumatic section; wherein, the liquid polymer derived ceramic precursor is cured in the extruder barrel to form a cured polymer derived ceramic material.

Moreover, there is provided these systems and methods having one or more of the following features: wherein the extruder barrel has 3 zones; and the pneumatic device cools the material; wherein the extruder barrel has 5 zones; wherein the pneumatic device mixes the material; wherein the extruder barrel has 8 zones, the zones comprising: an input zone having a temperature of 200-400 F; a first mix zone having a temperature of 200-400 F; a second mix zone having a temperature of 350-500 F; a third mix zone having a temperature of 350-500 F; a first mix/transfer zone having a temperature of 375-500 F; a second mix/transfer zone having a temperature of 375-550 F; a first transfer zone having a temperature of 375-425 F; and a die zone having a temperature of 50-80 F; wherein the extruder barrel has 8 zones, the zones comprising: an input zone; a first mix zone; a second mix zone having a temperature of 350-500 F; a third mix zone having a temperature of 350-500 F; a first mix/transfer zone having a temperature of 375-500 F; a second mix/transfer zone; a first transfer zone having a temperature of 375-425 F; and a die zone having a temperature of 50-80 F, and wherein the pneumatic device transports the material; wherein the extruder barrel has 8 zones, the zones comprising: an input zone having a temperature of 200-400 F; a first mix zone having a temperature of 200-400 F; a second mix zone having a temperature of 350-500 F; a third mix zone; a first mix/transfer zone; a second mix/transfer zone; a first transfer zone; and a die zone having a temperature of 50-80 F; wherein the extruder barrel has 8 zones, the zones comprising: an input zone having a temperature of 200-400 F; a first mix zone having a temperature of 200-400 F; a second mix zone having a temperature of 350-500 F; a third mix zone; a first mix/transfer zone; a second mix/transfer zone; a first transfer zone; and a die zone; wherein, the liquid polymer derived ceramic precursor is selected from the group consisting of silanes, polysilanes, silazanes, polysilazanes, carbosilanes, polycarbosilanes, siloxanes, and polysiloxanes; wherein, the liquid polymer derived ceramic precursor is a polysilocarb and wherein the gas temperature in the pneumatic device is a selected from the group costing of 10-100 F, 10-40 F, 20-50 F, 30-60 F, and 20-45 F; wherein, the liquid polymer derived ceramic precursor comprises a polysilocarb and contains hydride groups and wherein the gas temperature in the pneumatic device is a selected from the group costing of 10-100 F, 10-40 F, 20-50 F, 30-60 F, and 20-45 F; wherein the liquid polymer derived ceramic precursor comprises a polysilocarb having hydride and vinyl groups and wherein the molar ratio of hydride groups to vinyl groups is about 1.50 to 1 and wherein the gas temperature in the pneumatic device is a selected from the group costing of 10-100 F, 10-40 F, 20-50 F, 30-60 F, and 20-45 F; and wherein the liquid polymer derived ceramic precursor comprises a polysilocarb having hydride and vinyl groups and wherein the molar ratio of hydride groups to vinyl groups is about 3.93 to 1 and wherein the gas temperature in the pneumatic device is a selected from the group costing of 10-100 F, 10-40 F, 20-50 F, 30-60 F, and 20-45 F;.

Still further there is provided a method of making cured volumetric shapes of a polysilocarb polymer derived ceramic, the method comprising: providing an extruder having a drive section; the drive section mechanically engaging a gear box; and the gear box mechanically engaging a first and a second screw; whereby the drive section and gear box form an assembly capable of rotating the screws; the screws being located within an extruder barrel; the extruder barrel having a distal end and a proximal end; the extruder barrel and screws configured to form a plurality of sections; adding a liquid polymer derived ceramic precursor to a first barrel section comprising an injection port, the injunction port in fluid communication with a holding tank for the liquid polymer derived ceramic precursor; the first barrel section filled with the liquid polymer derived ceramic precursor; and curing the liquid polymer derived ceramic material in the first barrel section;the screws in the first barrel section advancing the liquid precursor distally toward a second barrel section; the second barrel section curing the liquid into a partially cured gelatinous polymer derived ceramic precursor; at least a portion of the second barrel section filled with the partially cured gelatinous polymer derived ceramic precursor; the screws in the second barrel section advancing the gelatinous polymer derived ceramic precursor distally toward a third barrel section curing the gelatinous precursor into a cured solid polymer derived ceramic precursor; at least a portion of the third barrel section filled with the cured solid polymer derived ceramic precursor; a pneumatic section; and the distal end of the barrel having an opening, the opening ejecting the cured solid polymer derived ceramic precursor into the pneumatic section.

Additionally there is provided a system for making small volumetric structures from a polymer derived ceramic precursor, the system comprising: a heat exchanger reactor, capable of forming a polymer derived ceramic precursor, the reactor in fluid communication with a polymer derived ceramic precursor delivery apparatus; the polymer derived ceramic precursor delivery apparatus comprising: an injection port; and, an extruder barrel having a plurality of sections; wherein a section of the plurality of sections is a mixing section having a temperature from about 70 C to about 300 C; a pneumatic cooling and transport section; wherein, the system is capable of receiving a liquid polymer derived ceramic precursor; and whereby the system is capable of curing the liquid polymer derived ceramic precursor in the extruder barrel to form a cured polymer derived ceramic material.

Moreover there is provided a method for making small volumetric structures from a polymer derived ceramic precursor, the method comprising: making a liquid polymer derived ceramic precursor using a heat exchanger reactor; adding the liquid polymer derived ceramic precursor to an extruder apparatus, the extruder comprising: an injection port; and, an extruder barrel having a plurality of sections; wherein a section of the plurality of sections is a mixing section having a temperature from about 70 C to about 300 C; a pneumatic section; wherein, the liquid polymer derived ceramic precursor is cured in the extruder barrel to form a cured polymer derived ceramic material.

Moreover, there is provided these systems and methods having one or more of the following features: wherein the pneumatic device performs one, more than one, or all, of the processes selected from the group consisting of mixing, milling, cooling, and transporting; wherein the pneumatic device uses a gas selected from the group consisting of air, nitrogen helium, and argon; wherein the gas temperature is selected from the group costing of 50-200 F, 10-100 F, 10-40 F, 20-50 F, 30-60 F, and 20-45 F; wherein the polymer derived ceramic precursor comprises a polysilocarb; and wherein the method comprises reacting a first polysilocarb precursor with an organic crosslinking agent.

Yet additionally, there is provide a method of making a cured volumetric structure from a polymer derived ceramic precursor, the method comprising: preheating methyl-hydrogen polysiloxane and dicyclopentadiene to 40° C in separate holding tanks; transferring through an inline static mixer to heat exchange reactor apparatus; adding 1000 ppm Pt Ashby's catalyst in xylenes (0.0339 lb/min) to the heat exchanger reactor apparatus; raising the temperare to to 60 ° C; whereby a liquid polymer derived ceramic precursor is formed; adding the liquid polymer derived ceramic precursor to an extruder apparatus, the extruder comprising: an injection port; and, an extruder barrel having a plurality of sections; wherein a section of the plurality of sections is a mixing section having a temperature from about 70 C to about 300 C; a pneumatic section; wherein, the liquid polymer derived ceramic precursor is cured in the extruder barrel to form a cured polymer derived ceramic material.

Moreover, there is provided these systems and methods having one or more of the following features: wherein the pneumatic section does not add any moisture to the cured material; wherein the pneumatic section keeps the material dry; wherein the pneumatic section uses a gas to cool and transport the cured material; wherein the heat exchanger apparatus comprises a shell and tube heat exchanger; wherein the heat exchanger apparatus comprises a plate heat exchanger; wherein the heat exchanger apparatus comprises a plate and shell heat exchanger; wherein the heat exchanger apparatus comprises an adiabatic heat exchanger; wherein the heat exchanger apparatus comprises a plate fin heat exchanger; wherein the heat exchanger apparatus comprises a pillow plate heat exchanger; wherein the heat exchanger apparatus comprises a phase change heat exchanger; wherein the heat exchanger apparatus comprises a direct contact heat exchanger; wherein the heat exchanger apparatus comprises a microchannel heat exchanger; wherein the heat exchanger apparatus comprises a spriral heat exchanger; wherein the heat exchanger apparatus comprises a regenerative heat exchanger; wherein the heat exchanger apparatus comprises a falling film evaporator; and wherein the heat exchanger apparatus comprises a wiped film heat exchanger reactor.

### BRIEF DESCRIPTION OF THE DRAWINGS

FIG. 1 is schematic cross sectional view of an embodiment of a process and apparatus of a pneumatic cooling and transport system in accordance with the present inventions.

FIG. 2 is a schematic view of an embodiment of a system and process in accordance with the present inventions.

FIG. 3 is a schematic view of an embodiment of a system and process in accordance with the present inventions.

### DESCRIPTION OF THE PREFERRED EMBODIMENTS

In general, the present inventions relate to methods, systems, apparatus, and process for making small volumetric shapes from PDC precursors, and to provide small volumetric shaped PDC preforms and polymer derived ceramics. In particular, among other things, embodiments of the present inventions make small shapes from PDC precursors at high rates and when extruders are configured with other forming or shaping apparatus can make these shapes with high levels of uniformity, e.g. same weight, same volume, same shape and variations and combinations of these attributes. Embodiments of the present inventions, among other things, make volumetric shapes of PDC precursors, PDC preforms, PDC plastics, PDC cured materials, and polymer derived ceramics, at high rates of production, in large quantities, and with long run times.

In general, embodiments of the present invention are directed toward extrusion processes in which one or more PDC precursors, as well as, potentially other materials are added into an extruder. The PDC precursors are reacted together in the extruder forming a PDC precursor batch, after which the PDC precursor batch is cured into a green, e.g., plastic, PDC material. This PDC material can then be further curried, proceeds, and pyrolized. In some embodiments a final PDC product, such as a SiOC pigment is provided, requirement no further processing and can be packaged for shipment to a customer.

The PDC precursors can be made in a reaction heat exchanger and the product from the reaction heat exchanger can be feed into the extruder, other materials and other precursors may also be added into the extruder along with material from the reaction heat exchanger material.

Heat exchanger reactor, reaction extrusion systems, and combinations and variations of these for use in making polymers, PDC, and SiOC PDCs are disclosed and taught in the priority document for this application U.S. Ser. No. 62/595,511, and in Published Application WO 2018/125861 published Jul. 5, 2018 the entire disclosure of each of which is incorporated herein by reference.

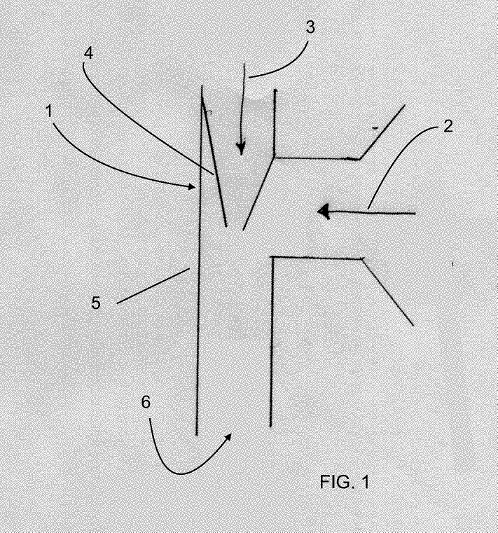

Turning to FIG. 1 there is a schematic diagram of a process and apparatus to perform both cooling and transport of the cured solid, or semi-solid material leaving the extruder. A pneumatic handling device 1 captures, collects, or directs the hot material leaving the extruder, as shown by arrow 2. The flowing gas, shown by arrow 3 transports the material to a holding bin, or directly to subsequent processing, such as washing, grinding, pyrolysis, and combinations and variations of these and other steps. In the embodiment of FIG. 1 there is also a flow restrictor 4, that accelerates the flow fo the gas, just as the gas is mixed with the hot material leaving the extruder. The volume and the velocity of the air flow should be sufficient, based upon the weight, size and shape of the particles exiting the extruder, and the rate that the particles are leaving the extruder, to transport, e.g., carry, the particles to their indented destination. Preferably, the restrictor 4 is a nozzle in the middle or to the downstream side of the product inlet and in this manner, employs the venturi effect to generate the velocity moving the material down the tube 5 to the outlet 6.

The gas can be any material that is in a gasses state at the selected operating temperatures and pressures. The gas can be, for example, air, nitrogen, helium, argon, CO₂. In an embodiment the gas is air that at a “cool” temperature (room temperature and below) and has a low dew point.

The flowing gas will cool the hot material that is leaving the extruder. Further depending on the material formulation and processing conditions, the cooling gas can be used to stop further reactions of the material.

Additionally, the venturi effect, can break up any agglomerates and the low temperature will cool the particles down.

In an embodiment, the gas velocity is sufficient to break up, mix or mill the material. Plates, flow paths, cyclonic devices, baffles, or other mechanical or mechanical-pneumatic type structures can be incorporated into the system to facilitate this milling or breaking up action, or other processing.

In an embodiment the gas is nitrogen, and avoids, or prevents the condensation of water on the material during packaging.

The materials of construction can be, for example, plexiglass, PVC, PE, PP, stainless steel, steel, steel alloy, etc. In a preferred embodiment the material is transparent. In embodiments where moisture is present in the motive gas, steel would be less preferred, because of the potential for rust formation.

In an embodiment, dry, cool air in a pneumatic transfer system (eg., FIG. 1, air blowing through a tube) is used to convey the SiOC cured solid material, material away from the extruder to a holding bin. In this manner the material is cooled without adding any moisture to it.

The gas can be at about 20° F to 600° F, at least about 50° F, at least about 100° F, at least about 100° F, about 200° F, from about 50° F to about 200° F, from about 150° F to about 300° F, from about 100° F to about 400° F, cooler than the material leaving the extruder, and combinations and variations and all values within these ranges. The contact time with the gas can be sufficient for the material to reach about the same temperature as the gas, within 10% of the temperature of the gas, within 20% of the temperature of the gas, within 30% of the temperature of the gas, within 40% of the temperature of the gas, from about 1% to about 70% of the temperature of the gas, from about 50% to about 150% of the temperature of the gas, greater and smaller temperature differences are contemplated.

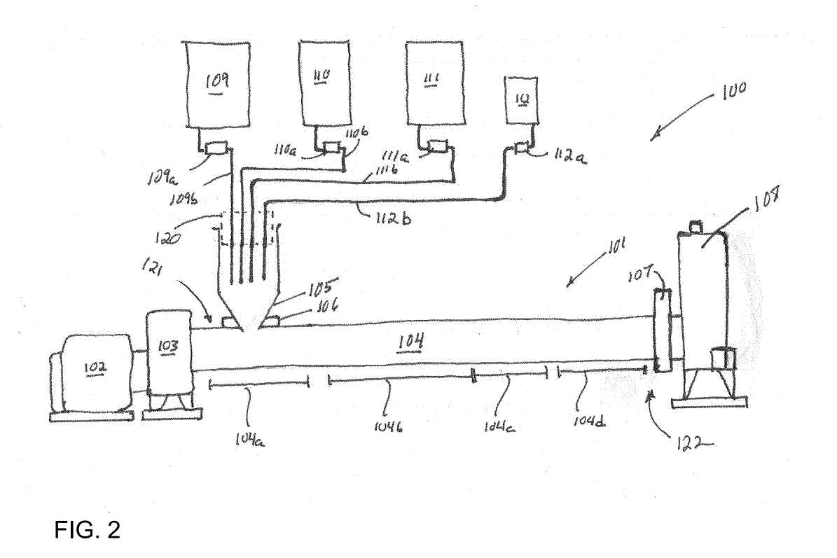

Turning to FIG. 2 there is a schematic flow diagram of a reaction extrusion pneumatic system and method (which systems and methods may also be called reactive extruders, reaction extrusion, and similar such terms). The reaction extrusion pneumatic system 100 has a reaction extruder 101. The reaction extruder 101 has a drive motor 102 and an extruder drive assembly 103, which drives, i.e., turns the extrusion screws (not shown) in barrel 104.

Barrel 104 may have several zones, having different temperatures, different pressure, different screw configurations, different rates of screw rotation, and combinations and variations of these and other conditions known or used in a reaction extrusion process. In the embodiment of FIG. 2 the barrel has four zones 104a, 104b, 104c, and 104d. The zones may have space between them in the barrel, e.g., see zone 104a and zone 104b, or they may be abutting, see zone 104b and zone 104c.

The screw configurations are selected primarily based upon the polymer derived ceramic precursors that are being used, including factors such as the level of catalysis used, the desired level of cure, the presence of an exothermic, and the viscosity of the precursor as it is reacted and proceeds to a cured material. Twin screw, with counter rotating screws are an embodiment that can be used, and in some situations may be preferable. Other embodiments of screws, and screw configurations include, for example, co-rotating, self wiping co-rotating, triple screw extruders, and combinations and variations of these. The screws can be made from, for example, steel, stainless steel, ceramics, alloys and combinations and variations of these and other materials know to the art

The length of the barrel may be greater than 30 in (“inches”), greater than 40 in, greater than 50 in, and greater than 100 in, the barrels may be from about 50 to about 240 in, about 50 to about 96 in, about 50 to about 166 in, about 96 in to about 150 in, and about 150 in to about 240 in. Preferably in some embodiments commercially available barrels have lengths of 84 in, 132 in and 166 can be utilized.

The diameter of the barrel may be greater than about ½ in, greater than about 1 in, greater than about 2 in, and greater than about 5 in, from about 1 in to about 7 in.

These various barrel lengths and various barrel diameters can be present in extruders, in many varied combinations. The ratio of the barrel length to barrel diameter, “L/D”, which is typically the manner in which extruder barrels can be referred to, can be, for example 36/1, 48/1, 50/1, 60/1 and other L/D ratios. Two, or more, barrels can be combined into a single extruder system. Thus, two 44/1 barrels can be combined in series to provide an 88/1 system. One, two, three, four or more barrels can be combined in series in this manner.

The temperatures in the barrel and in the various zones can vary from room temperature to about 600° C Various temperature heating profiles can be obtained within the barrel, e.g., a zone have a temperature increase of about ΔT, from the proximal to the distal end of the zone, a adjacent zone, where the temperature is held constant, and then subsequent zones where the ΔT can be increased, decreases or held to zero. In some embodiments cooling zones are contemplated, i.e., where the temperature is maintained below room temperature, or below a prior zone, to facilitate cooling of the material. ΔT in degree C for a zone in the barrel can be about 0, about 100, about 150, about 300, and about 400 or more. The lengths of these zones can be, for example, from about 10 in to 100 in, about 30 in to about 50 in, greater than 20 in, greater than 30 in, greater than 50 in.

At the distal end 122 of the barrel 104 there is located a throttling mechanism 107. This mechanism is designed to provide sufficient back pressure during the startup of the reaction extrusion process, to enable a steady state in the barrel 104 to be achieved. The mechanism 107 can be any time of valve, plate or other restriction know in the art, in some configurations it may not be needed, as the later, more distal zones, e.g., 104d, may provide sufficient back pressure at the beginning of a run.

Near the proximal end 121 of the barrel 104 there is an infeed device 105, and a closure or restriction device 106, which form an injection port or injector. The infeed device 105 receives the various PDC precursors, which typically are in liquid form at room temperature, and the restriction device 106, if needed, can control the infeed of the precursor material into the extruder 104, prevents flow back out of the extruder 104, and perform other operations as needed regarding the infeed of the precursor.

Although typically not needed with a reaction extrusion system 100, because the infeed materials are adequately, thoroughly mixed in the extruder by the action of the screws, a premixing zone 120, where one or more of the precursors or the in feed materials can be premixed is contemplated.

The system 100 can have several infeed material holding tanks. In the embodiment of FIG. 1 there four infeed holding tanks, 109, 110, 111 112. More or less infeed holding takes can be used. While the SiOC precursors are typically liquids at room temperature, and will be contained in the infeed tanks as a liquids, other PDC materials, and cross linkers, and additives may be solids, e.g., powders, emulsions, pastes, or in other forms. Additionally, other additives or fillers can be used, and held in the infeed tanks for use. In some embodiments it is desirable, and preferred to preheat the solid material to melt it forming a liquid for use in the injection or infeed port of the extruder. For example, DCPD which is a solid at room temperature, preferable is melted and added as a liquid to the extruder with a PDC precursor.

In an embodiment of the system of FIG. 1, tank 109 holds a first PDC precursor material, tank 110 holds a cross-linking agent, tank 111 holds a second PDC precursor, and tank 112 holds a catalyst solution. Each infeed tank has a metering device 109a, 110a, 111a and 112a and infeed line 109b, 110b, 111b, and 112b associated with it for delivery of the infeed material, preferably in a controlled and monitored manner, to the infeed assembly 105.

In a preferred embodiment: the first PDC precursor infeed material in tank 109 is a linear SiOC precursor; the cross-linking agent infeed material in tank 110 is a non-silicon based cross linking agent; and the second PDC precursor infeed material in tank 111, is a cyclic silicon based material.

The infeed materials of tanks 109, 111, can be feed into the extruder 104 in proportions, by weight, of about 0% to 100% of the total infeed material. The cross-linking agent of tank 110 can be feed into the extruder 104 in propositions by weight of about 0% to 85% of the total infeed material. The catalyst, based upon weight of active catalyst, can be from about 0% to about 10% of the weight of the other infeed materials.

The cross-linking agents, can be the reaction product of a non-silicon based cross linking agent and a siloxane backbone additive, and combinations and variation of these. The non-silicon based cross-linking agents are intended to, and provide, the capability to cross-link during curing. For example, non-silicon based cross-linking agents that can be used include: cyclopentadiene (CP), methylcyclopentadiene (MeCP), dicyclopentadiene (“DCPD”), methyldicyclopentadiene (MeDCPD), tricyclopentadiene (TCPD), piperylene, divnylbenzene, isoprene, norbornadiene, vinylnorbornene, propenylnorbornene, isopropenylnorbornene, methylvinylnorbornene, bicyclononadiene, methylbicyclononadiene, propadiene, 4-vinylcyclohexene, 1,3-heptadiene, cycloheptadiene, 1,3-butadiene, cyclooctadiene and isomers thereof. Generally, any hydrocarbon that contains two (or more) unsaturated, C═C, bonds that can react with a Si—H, Si—OH, or other Si bond in a precursor, can be used as a cross-linking agent. Some organic materials containing oxygen, nitrogen, and sulphur may also function as cross-linking moieties.

At the distal end 122 of the extruder 104 there is a pneumatic transport unit 108. The pneumatic transport can be, for example, of the general type as shown in the embodiment of FIG. 1. In an embodiment the unit 108 can be a cooling-pnuematic transport device. The solid polymer derived ceramic material is delivered from the distal end 122 of the extruder 104 to the until 108. The solid polymer derived ceramic material from the distal end 122 of the extruder 104 can be initially cured, finally cured or hard cured. This PDC material can be a final product, e.g., a proppant bead or flake, or can be subject to later shaping, grinding, curing, molding, pyrolzing, etc. Thus, the unit 108, can transport the material to, for example, a simple bin to hold the cured material, to a packaging device, to an forming or shaping device, such as those disclosed in U.S. patent applications Ser. Nos. 15/210,590 and 15/002,773, the entire disclosures of each of which are incorporated herein by reference. The unit 108 can transport the material directly to a further curing furnace, or it can transport the material directly to a pyrolysis furnace, or both.

Typically, conditions inside the barrel of the extruder, e.g., during mixing, reacting and curing are essentially under conditions with little to no atmosphere, and thus little to no oxygen or nitrogen. Thus, under typical operating parameters the conditions inside of the barrel are essentially inert. In some embodiments gasses may be added, for example for the purpose of further controlling the reaction, modifying the infeed materials or formulations, and combinations of these and other purposes. For example, propylene, butene, other alkenes, or other organics in gaseous form can be added to the injection port. The gas is preferably capable of reacting with the of the precursor material, and added under conditions where this reaction can take place without bubble formation. Thus, preferably the reaction of the gas and the precursor material are completed by the time the precursor material is in a gel state. More preferably the gas reacts with the backbone of the precursor material.

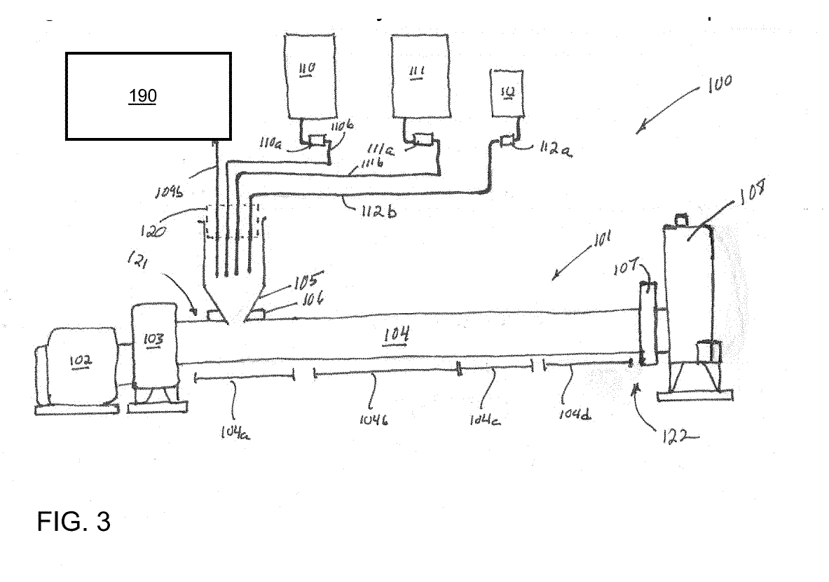

FIG. 3 shows an embodiment of the system of FIG. 2, where the one of the material holding tanks has been replaced with a heat exchanger reactor 190. (Like numbers indicating like components.) Any suitable heat exchanger reactor may be used, including the heat exchanger reactors taught and disclosed in U.S. patent application Ser. No. 16/041,801, the entire disclosure of which is incorporated herein by reference.

It should be understood that the use of headings in this specification is for the purpose of clarity, and is not limiting in any way. Thus, the processes and disclosures described under a heading should be read in context with the entirely of this specification, including the various examples. The use of headings in this specification should not limit the scope of protection afford the present inventions.

### EXAMPLES

The following examples are provided to illustrate various embodiments of reaction extrusion systems and methods that can be used to make PDC cured materials, as well as examples of polysilocarb precursors that can be formed into cured preforms, by extrusion systems and processes. These examples are for illustrative purposes and should not be viewed as, and do not otherwise limit the scope of the present inventions. It should be understood the term polysilocarb batch includes both catalyzed and uncatalyzed batches. The percentages used in the examples, unless specified otherwise, are weight percents of the total batch, preform or structure.

### Example 1

In an embodiment the extruder has 8 temp control zones and is using a 50:50 MHF:DCPD PDC precursor to form a PDC cured material, with the following temperature profile, per zone type:
Input zone—350 F
Mix zone—350 F
Mix zone—400 F
Mix zone—400 F
Mix/transfer zone—425 F
Mix/transfer zone—450 F
Transfer zone—400 F
Die zone—60 F
Pneumatic receiving and transport device, air temperature 45-60 F

### Example 2

Table 1 provides extruder conditions for a PDC formulation

TABLE 1

| | | | Temperature (degree F.) | | | | | | Screw Speed |
|---|---|---|---|---|---|---|---|---|---|
| MH Fluid | DCPD | P01 Catalyst | 1 | 2 | 3 | 4 | 5 | 6 | (lb/hr) |
| 50 | 50 | 0.015 | 300 | 300 | 500 | 500 | 500 | 500 | 50 |
| 50 | 50 | 0.015 | 300 | 300 | 500 | 500 | 500 | 500 | 40 |
| 50 | 50 | 0.015 | 300 | 300 | 500 | 500 | 500 | 500 | 30 |
| 50 | 50 | 0.015 | 300 | 300 | 500 | 500 | 500 | 500 | 20 |
| 50 | 50 | 0.025 | 300 | 300 | 500 | 500 | 500 | 500 | 50 |
| 50 | 50 | 0.025 | 300 | 300 | 500 | 500 | 500 | 500 | 30 |
| 50 | 50 | 0.025 | 300 | 300 | 500 | 500 | 500 | 500 | 20 |
| 50 | 50 | 0.015 | 300 | 400 | 500 | 500 | 500 | 500 | 20 |
| 50 | 50 | 0.015 | 300 | 400 | 500 | 600 | 600 | 600 | 50 |
| 50 | 50 | 0.015 | 300 | 400 | 500 | 600 | 600 | 600 | 30 |
| 50 | 50 | 0.015 | 300 | 400 | 500 | 600 | 600 | 600 | 20 |
| 50 | 50 | 0.025 | 300 | 400 | 500 | 600 | 600 | 600 | 20 |

Pneumatic receiving and transport device, air temperature 45-70 F

### Example 3

A twin screw extruder is used to produce cured PDC material from a precursor formulation of 50% methyl hydrogen fluid and 50% DCPD. The cured polysilocarb material is a white crumb, that is received by and transpored with a pneumatic device of the type shown in FIG. 1, having nitrogen as the gas at a temperature of 50 F, that transports the material to a station where it can be further worked, e.g., shaped, ground, cured, pyrolized. A 3% catalyst loading is used. The catalyst can be mixed with DCPD before going into the extruder. A shaker table or conveyor belt moving material away from the extruder is used to move the cured material away from the extruder. The cured material is still curing as it leaves the extruder, and can continue to cure for some time. In some embodiments, especially in view of the exotherm, and the material's self-insulative nature, the material upon leaving the extruder should be separated. and preferably not permitted to agglomerate or pile up.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

It is also noted that although the present specification focuses on small PDC volumetric shapes, to solve the long-standing need for methods and systems to obtain such articles, the systems, technologies and methods of the present specification can have application for larger shapes and structures. Thus, the scope of protection for the present inventions should not be limited to, and extend to and cover larger shapes and volumes, unless specially state otherwise.

It should be understood that the use of headings in this specification is for the purpose of clarity, and is not limiting in any way. Thus, the processes and disclosures described under a heading should be read in context with the entirely of this specification, including the various examples. The use of headings in this specification should not limit the scope of protection afford the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and with existing equipment or activities which may be modified, in-part, based on the teachings of this specification. Further, the various embodiments set forth in this specification may be used with each other in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular Figure.

The invention may be embodied in other forms than those specifically disclosed herein without departing from its spirit or essential characteristics. The described embodiments are to be considered in all respects only as illustrative and not restrictive.

1. A system for making small volumetric structures from a polymer derived ceramic precursor, the system comprising:
a. a polymer derived ceramic precursor delivery apparatus comprising:
i. an injection port; and,
ii. an extruder barrel having a plurality of sections;
iii. wherein a section of the plurality of sections is a mixing section having a temperature from about 70 C to about 300 C;
iv. a pneumatic cooling and transport section;
b. wherein, the system is capable of receiving a liquid polymer derived ceramic precursor; and whereby the system is capable of curing the liquid polymer derived ceramic precursor in the extruder barrel to form a cured polymer derived ceramic material.

2. The system of claim 1, wherein the injection port is filled with a liquid polymer derived ceramic precursor; wherein the pneumatic cooling and transport section comprises a gas inlet, a cured polymer derived ceramic material inlet, a venture chamber, and an outlet.

3. The system of claim 2, wherein the extruder barrel is filled with the polymer derived ceramic precursor formulation.

4. The system of claim 3, wherein the extruder barrel has a distal end and a proximal end, wherein the proximal end is adjacent the injunction port; and wherein the distal end of the barrel is filled with cured polymer derived ceramic material.

5. An extruder system for making cured polysiloxane polymer derived ceramic materials the extruder comprising:
a. a drive section;
b. the drive section mechanically engaging a gear box; and the gear box mechanically engaging a first and a second screw; whereby the drive section and gear box form an assembly capable of rotating the screws;
c. the screws being located within an extruder barrel;
d. the extruder barrel having a distal end and a proximal end;
e. the extruder barrel and screws configured to form a plurality of sections;
f. a first barrel section comprising an injection port having a liquid polymer derived ceramic precursor, the injunction port in fluid communication with a holding tank for the liquid polymer derived ceramic precursor;
g. the first barrel section filled with the liquid polymer derived ceramic precursor; the first barrel section configured to cure the liquid polymer derived ceramic precursor;
h. the screws in the first barrel section configured to advance the liquid precursor distally toward a second barrel section; the second barrel section configured to cure the liquid into a partially cured gelatinous polymer derived ceramic precursor;
i. at least a portion of the second barrel section filled with the partially cured gelatinous polymer derived ceramic precursor;
j. the screws in the second barrel section configured to advance the gelatinous polymer derived ceramic precursor distally toward a third barrel section configured to cure the gelatinous precursor into a cured solid polymer derived ceramic precursor;
k. at least a portion of the third barrel section filled with the cured solid polymer derived ceramic precursor;
l. the distal end of the barrel having an opening, the opening at least partially filled with the cured solid polymer derived ceramic precursor; and,
m. the distal end in operational association with a pneumatic section, whereby the cured precursor is provided into an inlet of the pneumatic section and mixed with an in flowing gas stream, whereby the cured material is carried by the gas stream.

6. The system of claim 5, wherein the polymer derived ceramic precursor comprises methyl hydrogen fluid; and wherein the pneumatic section cools the cured material, transports the material to a predetermined destination, or both.

7. The system of claim 5, wherein the polymer derived ceramic precursor comprises DCPD.

8. The system of claim 5, wherein the polymer derived ceramic precursor comprises DCPD and methyl hydrogen fluid.

9. A method for making volumetric structures defining a volume, in a reaction extruder, the method comprising: adding a liquid polymer derived ceramic precusor into an extruder, the extruder comprising a barrel, mixing and curing the liquid polymer derived ceramic in the barrel, and delivering from the barrel into a pneumatic section a cured polymer derived ceramic material.

10. The method of claim 9, wherein the volume is less than about 0.25 inch³ and wherein the gas temperature in the pneumatic device is selected from the group costing of 10-100 F, 10-40 F, 20-50 F, 30-60 F, and 20-45 F.

11. The method of claim 9, wherein the volume is less than about 500 mm³ and wherein the gas temperature in the pneumatic device is selected from the group costing of 10-100 F, 10-40 F, 20-50 F, 30-60 F, and 20-45 F.

12. The method of claim 9, wherein the volume is than about 50 microns³ and wherein the gas temperature in the pneumatic device is selected from the group costing of 10-100 F, 10-40 F, 20-50 F, 30-60 F, and 20-45 F.

13. The method of claim 9, wherein the preform is green cured and wherein the gas temperature in the pneumatic device is selected from the group costing of 10-100 F, 10-40 F, 20-50 F, 30-60 F, and 20-45 F.

14. The method of claim 9 wherein the liquid polymer derived precursor ceramic comprises methyl hydrogen fluid; and wherein the pneumatic section cools the cured material, transports the material to a predetermined destination, or both,

15. The method of claim 9, wherein the liquid polymer derived ceramic precursor comprises DCPD; and wherein the pneumatic section cools the cured material, transports the material to a predetermined destination, or both.

16. The method of claim 9, wherein the liquid polymer derived ceramic precursor comprises DCPD and methyl hydrogen fluid; and wherein the pneumatic section cools the cured material, transports the material to a predetermined destination, or both.

17-41. (canceled)
